(19) United States
(12) Patent Application Publication
(10) Pub. No.: US 2003/0053166 A1
(43) Pub. Date: Mar. 20, 2003

(54) Method and apparatus of transmitting several digital signals over a common optical fiber

(76) Inventors: Russell O. Hamm, New York, NY (US); Andrew Karlin, Livingston, NJ (US)

Correspondence Address: GOTTLIEB RACKMAN & REISMAN PC, 270 MADISON AVENUE, 8TH FLOOR, NEW YORK, NY, 100160601

(21) Appl. No.: 09/952,114

(22) Filed: Sep. 14, 2001

(51) Int. Cl. H04J 14/02; H04B 10/04

(52) U.S. Cl. 359/124; 359/180

(57) ABSTRACT

An apparatus and method for transmitting simultaneous independent data signals over an optical fiber includes converting the data signals into corresponding optical signals and introducing the optical signals into the fiber without necessarily reformatting the data signals to conform to communication standards or synchronizing them. The data signals could include digital streaming video signals, voice signals, data signals etc.

### BACKGROUND OF THE INVENTION

A. Field of Invention

This invention pertains to a method and apparatus for transmitting several digital signals, including for example, streaming digital video signals, over a common optical fiber. More specifically, the subject application pertains to a method and apparatus in which several digital signals are transmitted over a common fiber asynchronously and independently of each other.

B. Description of the Prior Art

Historically, methods for transmitting multiple signals over a single communication means were first developed for sinusoidal electrical signals. For most efficient results, the frequency domain was partitioned into channels and these channels were then used to send the electrical signals using various encoding techniques. However, it was quickly determined that one problem with this scheme was that on some channels distortion was generated by the harmonic interference between signals at certain specific frequencies. In order to eliminate these distortions, certain protocols were adapted by the telecommunications industry that dictated that only certain channels were to be used for signal transmissions. Moreover, signals were also synchronized between channels to further eliminate cross-channel distortions.

When optical fibers started being used for signal transmissions, the techniques and protocols developed for electrical signals were carried over to eliminate cross channel interference. For example, present telecommunication standards for digital data set for all data streams by the ITU(International Telecommunications Union) require a sampling frequency of 8 KHz, a word size 8 bits and the following frequencies in the MHz range: 0.064, 1.5; 44.74; 155.52; 622.08 and 2,488.32 MHz. Restricting the allowable frequencies at which data can be transmitted implicitly limits the corresponding rates at which data can be transmitted as well.

However, in many fields these restrictions cause difficulties and severely limit the ability of a channel to carry data streams other than telecommunication signals because most of them are controlled by different standards. For example, digital video signals must conform to standards defined by the SMPTE (Society of Motion Picture and Television Engineers). SMPTE 259M regulates several standard television signals. For example, for the 4:2:2 component 4×3 transmission, it specifies a sampling frequency of 13.5 MHz for the 10 bit luminance signal and a sampling frequency of 6.75 MHz for the two chrominance channels, resulting in a combined series of bits at a data rate for the standard television signal of 270 Mb/s. for NTSC 4f the composite rate its 143 mb/s, for PAL 4f the composite bit rate is 177 Mb/s and for the 4:2:2 component 16×9 signal the bit rate is 360 Mb/s. SMPTE 292M regulates HD(High Definition) Television signals and specifies a sampling frequency of 74.25 MHz resulting in a streaming digital video signal of 1.485 Gb/s.

All these rates are non-integer multiples of the channel frequencies defined by the ITU standards. Moreover, the problem is complicated further by the differences in the sampling rates and digital words. Therefore, presently before standard digital video signals can be transmitted over telecommunication systems, they must be converted to formats that meet the ITU standards. This is a non-trivial process that requires intensive signal processing and has many other disadvantages.

More specifically three schemes are presently available for transmitting these types of digital signals over optical cables. All of them involve some kind of compromise between the quality of the signal being transmitted and efficient use of the bandwidth. The first of these schemes uses a codec that processes the video signals in a manner that fits the video data rate to one of the above-named frequency channels. For example, to fit the video signal to the standard 45 MHZ the codec must compress the video signal by a ratio of about 6:1. This compression may be accomplished using one or more well known compression methods such as MPEG, which removes temporal data by eliminating some of the video frames, using wavelets, which removes spatial data and converting the digital video signals into corresponding analog signals and then sampling the analog signal at a lower frequency. Thus, using a codec causes loss of picture detail, introduces noise and greatly reduces the quality of the transmitted pictures.

A second scheme of transmitting streaming digital video consists of converting the video signals into files of data using digital processing. These files are then transmitted in packets over a standard telecommunication channel using computer industry standards. Two types of packets are presently in common use: ATM and IP. Because of the high data rate of a streaming video signal, compression is generally used to reduce the size and/or the number of the packets for more efficient transmission. However, compression downgrades the picture quality, as discussed above. Moreover, conversion into digital packets is an intensive process requiring extensive computational capabilities and buffering. Finally, the required signal processing takes time and hence, introduces delays which are not acceptable for live video broadcasting.

The third scheme involves bit stuffing. This scheme involves adding additional bits to the streaming video signals to the next standard telecommunication channel, i.e., 622 MHz.

These additional bits are superfluous and are removed at the receiving end and discarded. Obviously this scheme wastes a lot of bandwidth. For example, conversion from 270 MHz to 622 MHz requires more stuffing bits than data bits and therefore it is obviously very inefficient.

### OBJECTIVES AND SUMMARY OF THE INVENTION

In view of the abovementioned disadvantages of the prior art, it is an objective of the present invention to provide an efficient and fast apparatus and method for transmitting streaming digital video signals over an optical fiber.

A further objective is to provide a method and apparatus that transmits video signals in their natural format, i.e., without the need to translate the signals into a different format.

A further objective is to provide a method and apparatus that can be used to transmit several different optical signals over a single optical fiber without restricting the wavelengths of the individual optical signals, or synchronizing the signals to each other or to any common sync signals.

Other objectives and advantages of the invention shall become apparent from the following description of the invention.

Briefly, an apparatus for transmitting signals in accordance with this invention can be used to transmit several types of different digital input signals, such as a streaming digital data signal, a HDTV signal and voice signals simultaneously by the device on a single optical fiber. For this purpose, several electrical to optical converters are provided, each converter converting one of the digital input signals to corresponding optical signals at a particular wavelength. The optical signals generated by different converters have different wavelengths. However, no other restriction is required. The optical signals are not synchronized. An optical multiplexer is provided as a combining element to multiplex the optical signals and transmit them over the optical fiber. The optical multiplexer may be a DW D multiplexer.

Voice and other similar signals normally handled by communication equipment can be fed into a SONET multiplexer which converts these signals using the appropriate communications standards. The resulting optical signal is synchronized to a standard sync signal and is transmitted to the fiber through the optical multiplexer.

### BRIEF DESCRIPTION OF THE DRAWINGS

FIG. 1 shows a block diagram of a standard prior transmitter for transmitting multiple signals over an optical fiber;

FIG. 2 shows a block diagram of a transmitter for transmitting multiple signals over an optical fiber in accordance with the present invention;

FIG. 3A shows a layered representation of the prior art transmitter of FIG. 1;

FIGS. 3B and 3C show layered representations of the transmitter of FIG. 2.

### DETAILED DESCRIPTION OF THE INVENTION

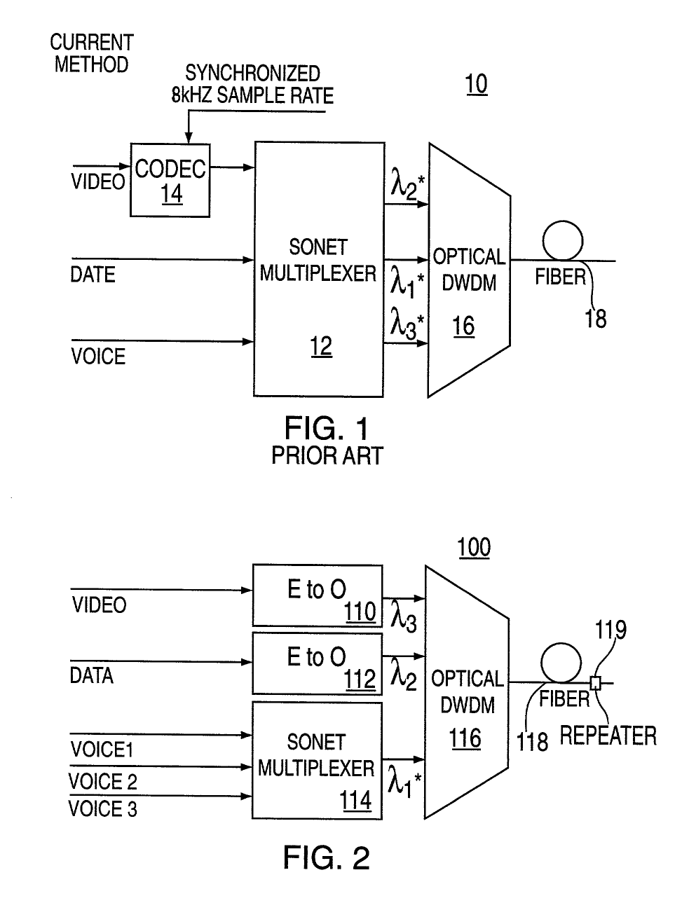

In order to provide a better understanding of the invention, a typical known apparatus and method of transmitting information over an optical fiber is first described in conjunction with FIG. 1. The apparatus shown in this Figure is used to send three different types of signals simultaneously: a standard voice signal, a data signal and a streamed video signal. The voice and data signals are fed to SONET (Synchronous Optical NETwork) multiplexer. The data and voice signals are processed by the multiplexer without any additional manipulations required. However, as discussed above, typically the video signal is not directly compatible with the SONET standards and hence, it must be processed first by a codec 14. Importantly, because the SONET standards require that all the inputs to the SONET multiplexer 12 be synchronized, the codec 14 receives a 8 kHz sync signal, compresses the video signal as discussed above, and then generates a synchronized output.

The SONET multiplexer 12 encodes these signals into optical signals at specific wavelengths λ1*, λ2* and λ3* in accordance with the standards of the communication industry. An asterisk has been added to the designations of these three signals in FIG. 1 to indicate, that as required by the international standards, the signals are synchronized. In some instances a single output optical signal may be sufficient to carry all the information, in which case the optical DWD multiplexer may be replaced by a standard optical interface device adapted to transmit the optical signal to the optical fiber 18.

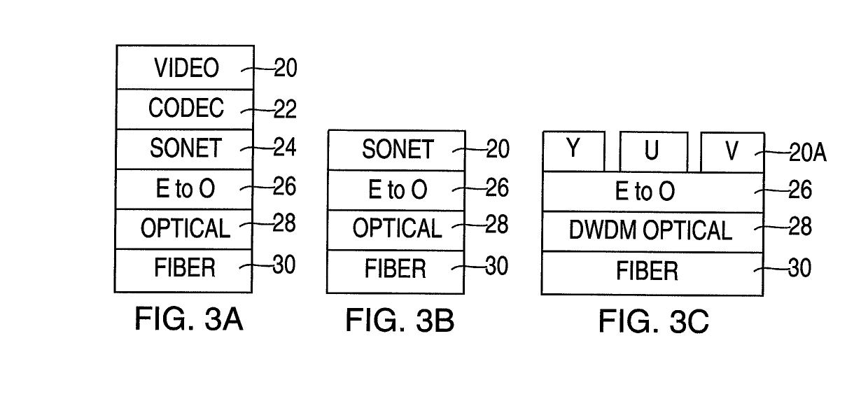

FIG. 3A shows another representation of the equipment and processes required to transmit streaming digital video signals to a remote location. In this figure each step or process is shown as a layer. The first layer 20 represents the generation of the streaming digital video signals. The next layer 22 represents the conversion of the video signals by the codec 14. The third layer 24 represents the processing of the converted signals by the SONET multiplexer to fit the standard telecommunication format. The fourth layer 26 represents the conversion of the electrical signals into corresponding optical signals. The fifth layer represents the multiplexing of several optical signals by the DWDM 16 and other optical manipulations that may be required such as amplification, filtering and so forth. The six layer 30 represents the transmission of the optical signals over the optical fiber 18.

The present inventors have discovered, that contrary to accepted wisdom in the art, optical signals do not interfere with each other and hence when multiple optical signals are fed into the same optical fiber, the wavelengths of these optical signals can be selected almost at random, as long as there is a minimum separation between them. Based on present technology, this minimum wavelength separation could be 50 nm, but as technology progresses, it is getting smaller and smaller. Therefore all the disadvantages of the prior art in which adherence to standards associated with electrical signals can be disregarded. An apparatus 100 for transmitting various signals in accordance with the subject invention is shown in FIG. 2. Apparatus 100 includes a separate component for processing each incoming signal is converted into a respective digital signal by a corresponding digital component. Thus, the streaming digital video signals are fed to an electric to optical (E/O) converter 110 and the data signal is fed to a similar E/O converter 112. E/O optical converters of this type are available for example from Fujitsu.

The voice signals must still meet the requirements of the communication industry. Therefore the voice signals are converted into optical signals by a SONET multiplexer 114 as described above. For example, in FIG. 2 three separate voice signals, VOICE 1, VOICE 2, VOICE 3 are fed to the SONET multiplexer, which then combines these three signals in a synchronous manner. Each of these converting components generates corresponding optical signals having the respective wavelengths λ1, λ2, λ3*. Since the three signals are completely independent of each other, they must have different wavelengths but do not require any synchronization between each other. Moreover, λ1 and λ2 need no synchronization with respect to a sync signal either. λ3* is synchronized to the 8 KHz sync signal as discussed above. The three optical signals are fed to the optical DWD multiplexer 116 which multiplexes the optical signal and inserts the same into the optical fiber 18. At the remote end, the process is reversed. Importantly, since the signals having wavelengths λ1 and λ2 have not been converted to meet the communication industry standards, they can be readily converted into corresponding electrical signals and decoded to reconstruct the original digital signals.

If the optical fiber 118 is very long, one or more repeaters 119 which include a photonic amplifier used to amplify the optical signals to compensate for losses induced by the optical fiber. Repeaters of this kind are well known in the art and need not be described any further.

The apparatus 100 can be used to transmit several types of signals simultaneously and asynchronously over the same fiber without any interference therebetween. For example, the apparatus 100 may be used to transmit HDTV signals at 1.485 Gb/s, a 270 Mb/s streaming standard digital video signal and a voice channel generated by a SONET multiplexer at 2.488 Mb/s.

Moreover, as indicated in FIG. 3B the system 100 requires four layers; layer 20 generating the streaming digital video signals, layer 26 for the transformation of the electrical to the optical signals, layer 28 for the multiplexing and manipulation of the optical signals and layer 30 for the actual transmission of the optical signals. In effect then, the present invention eliminates layers 22 and 24 from the standard video signal transmission system of FIG. 3A. Moreover, the requirement for synchronizing the different optical signals has also been eliminated.

In FIG. 3 layer 20A has been expanded to show the generation of not only the streaming video signal (Y) but also the generation of other data streams (U) and voice signal streams (V). As discussed above, and in relation to FIG. 2, each of these signal streams is processed independently to generate corresponding optical signals which then travel within the common fiber 18.

Obviously numerous modifications may be made to this invention without departing from its scope as defined in the appended claims.

We claim:

1. An optical transmitter for transmitting a plurality of electrical signals over an optical fiber comprising:
a plurality of electrical to optical converters, each converter receiving one of said electrical signals into a corresponding optical signal at a specific frequency; and
a combining element receiving said optical signals and introducing said signals into said optical fiber.

2. The transmitter of claim 1 wherein said electrical to optical converters generate respective optical signals that are independent of each other.

3. The transmitter of claim 1 wherein at least one of said electrical to optical converters is adapted to synchronize its optical signal to a predetermined sync signal.

4. The transmitter of claim 1 wherein said combiner is a DWD multiplexer.

5. The transmitter of claim 1 wherein at least one of said electrical to optical converters is a SONET multiplexer.

6. An apparatus for transmitting a plurality of streaming digital signals comprising:
a plurality of electrical to optical converters, each converter receiving one of said digital signals and generating a corresponding optical signals, the optical signals from different converters having different wavelengths; and
an optical combining element adapted to combine said optical signals and feed them to an optical fiber.

7. The apparatus of claim 6 wherein said optical combining element is an optical DWD multiplexer.

8. The apparatus of claim 6 wherein one of said electrical to optical converters is a SONET multiplexer.

9. The apparatus of claim 8 wherein said SONET multiplexer is adapted to receive several signals and to combine them into a single synchronized output signal.

10. The apparatus of claim 6 wherein said converters generate said optical signals without synchronization therebetween.

11. A system for transmitting a plurality of electrical signals over long distances comprising:
a transmitter including a plurality of converters adapted to convert said electrical signals into corresponding optical signals without changing format; and a multiplexer adapted to multiplex said optical signals and generating multiplexed optical signals; and
an optical fiber receiving said multiplexed optical signals and transmit them to a remote location.

12. The system of claim 11 further comprising a repeater coupled to said optical fiber.

13. The system of claim 11 further comprising a SONET multiplexer, said SONET multiplexer receiving other signals and generating an optical signal that is multiplexed by said multiplexer.

14. The system of claim 13 wherein said SONET multiplexer receives and converts several voice signals.

15. The system of claim 14 wherein said SONET multiplexer synchronizes said voice signals.

16. The system of claim 11 wherein said transmitter is adapted to receive a streaming digital video signal for transmission.

17. The system of claim 11 wherein said transmitter is adapted to receive an HDTV signal for transmission.

18. The system of claim 11 further comprising a repeater adapted to amplify the signals in said optical fiber.

19. The system of claim 18 wherein said repeater is a photonic amplifier.

20. A method of transmitting a plurality of electrical data signals comprising:
converting said electrical signals into corresponding optical signals without synchronization;
combining the optical signals; and
sending said combined optical signals to a remote location over an optical fiber.

21. The method of claim 20 wherein said optical signals are multiplexed.

22. The method of claim 21 further comprising multiplexing said optical signals using an optical DWD multiplexer.

23. The method of claim 21 wherein said data signals includes a video signal and a voice signal, further comprising converting said voice signal into a digital communication channel format before generating an optical signal corresponding to said voice signal.

24. The method of claim 23 wherein said voice signal is formatted using a SONET multiplexer.
